(19) United States
(12) Patent Application Publication
(10) Pub. No.: US 2011/0153475 A1
(43) Pub. Date: Jun. 23, 2011

(54) FEDERAL ADJUSTMENT TRACKING SYSTEM

(75) Inventors: Cheryl HUEBSCHER, Rockaway, NJ (US); Larry W. BRENDLER, Bridgewater, NJ (US); Yelena BUCHIN, Morris Plains, NJ (US); Lisa E. LEWIS, Basking Ridge, NJ (US); Kathleen S. METZGER, West Paterson, NJ (US)

(73) Assignee: AT&T INTELLECTUAL PROPERTY I, L.P., Reno, NV (US)

(21) Appl. No.: 12/641,723

(22) Filed: Dec. 18, 2009

(51) Int. Cl. G06Q 40/00; G06Q 10/00

(52) U.S. Cl. 705/31; 705/30

(57) ABSTRACT

Tracking federal adjustments includes receiving an automated upload at a database, from a tax platform implemented on at least one processor, of at least one of: a beginning balance, a thirteenth period adjustment and an ending balance for a general ledger account. User input specifying a type of tax report is received. A report itemizing data stored in the database and calculations based on the data stored in the database, in accordance with the user input.

### BACKGROUND

1. Field of the Disclosure

The present disclosure relates to tracking and managing tax data. More particularly, the present disclosure relates to systems and methods for tracking federal adjustments.

2. Background Information

Large organizations typically require accounting spreadsheets to obtain requisite tax data to prepare financial accounting statements and corporate income tax returns. Accordingly, the spreadsheets may be updated to be in coordination with changes in tax status that occur throughout the year. Typically, a tax account manager is responsible for propagating updates throughout the accounting spreadsheets.

Terms and Definitions
Accounting Event—a code that identifies an entry that was itemized by Schedule M-1
Accrual—an estimate of tax liability and taxable income for the year
Accrual Accounting—an accounting method that measures the performance and position of a company by recognizing economic events regardless of when cash transactions occur
Adjustment—information computed outside the federal adjustment tracking system and entered into the system; adjustment information is retained and carried over into subsequent year
Extension—a revision to an accrual estimate, determined for the purposes of a federal income tax extension of time to file request, an estimated tax liability
Fas109-a U.S. accounting standard for income taxes that specifies how to present income tax expenses and liability for accounting purposes and to present to shareholders
General Ledger—a main accounting record of a business which uses double-entry book-keeping including both debit transactions and credit transactions
Issue—relates to a financial expense, liability or asset accounting topic (e.g., executive compensation, uncollectable accounts receivable, amortization, deferred compensation, pension expenses)
Legal Entity—a structure of an organization that affects an entities' liabilities
Manual Issue type—an entry that is computed outside of the federal adjustment tracking system; the calculated result is entered into the federal adjustment tracking system
Reclass—an accounting term that describes movement of an existing accounting balance from one place in a financial statement to another (i.e., from one financial account to another financial account) in the same accounting period
Schedule M-1—federal income tax return for corporations itemizing differences between taxable income and book accounting income
Segment—an internal, organizationally-defined structure to identify profitability by different operating divisions
Segment Roll Forward—an accounting term that describes a change in balance from one accounting period to another
Standard Issue type—an entry that is computed by the federal adjustment tracking system based on data elements input by the user or obtained from a tax platform

### BRIEF DESCRIPTION OF THE DRAWINGS

FIG. 1 shows an exemplary general computer system that includes a set of instructions for a federal adjustment tracking system;

FIG. 2 is a system diagram illustrating components of the federal adjustment tracking system, according to an aspect of the present disclosure,

FIG. 3 is a process flow diagram illustrating federal adjustment tracking, according to an aspect of the present disclosure;

FIG. 4a is a screen shot of a report screen of a web interface frontend of the federal adjustment tracking system, according to an aspect of the present disclosure;

FIG. 4b is a screen shot of a standard issues screen of the web interface frontend of the federal adjustment tracking system, according to an aspect of the present disclosure;

FIGS. 4c-4d are screen shots of issue fields associated with entered search criteria for a specified report, according to one aspect of the present application;

FIG. 4e is a screen shot of Fas 109 summary information displayed by the web interface fronted of the federal adjustment tracking system database, according to one aspect of the present application;

FIG. 4f is a screen shot of a manual issues screen of the web interface frontend to the federal adjustment tracking system database, according to one aspect of the present application;

FIG. 4g is a screen shot of M-1 summary information displayed by the web interface fronted of the federal adjustment tracking system database, according to one aspect of the present application; and

FIG. 4h is a screen shot of a table maintenance screen for accounting events displayed by the web interface frontend of the federal adjustment tracking system database, according to one aspect of the present application.

### DETAILED DESCRIPTION

In view of the foregoing, the present disclosure, through one or more of its various aspects, embodiments and/or specific features or sub-components, is thus intended to bring out one or more of the advantages as specifically noted below.

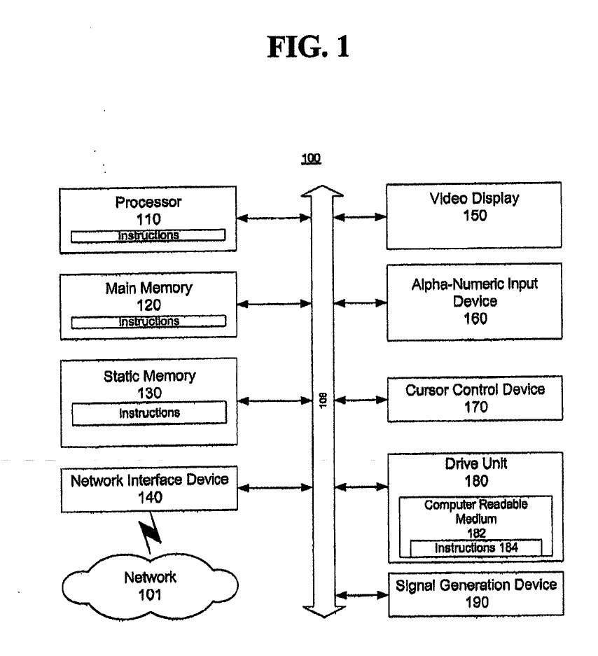

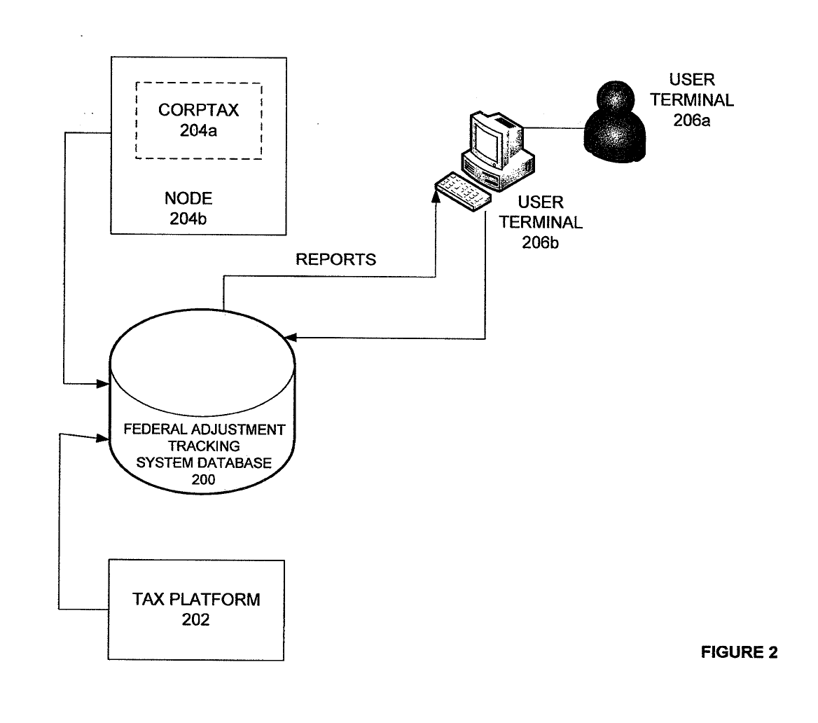

FIG. 1 is an illustrative embodiment of a general computer system, on which a method to provide a federal adjustment tracking system can be implemented, which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a global positioning satellite (GPS) device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

According to one aspect of the present application, an automated method of tracking federal adjustments includes receiving an automated upload at a database, from a tax platform implemented on at least one processor, of at least one of: a beginning balance, a thirteenth period adjustment and an ending balance for a general ledger account. The method includes receiving user input specifying a type of tax report. The method also includes automatically generating and outputting to a user terminal, a report itemizing at least one of: data stored in the database and calculations based on the data stored in the database, in accordance with the user input.

According to another aspect of the present application, the method includes receiving a manual upload, at the database, from a vendor application implemented on a second processor.

According to yet another aspect of the present application, n the user input designates a standard issue or a manual issue.

According to still another aspect of the present application, the user input further comprises a year, a selected issue, a general ledger account, a segment, a legal entity and a report format.

According to one aspect of the present application, a subset of data elements itemized by the report are editable.

According to another aspect of the present application, updating the data stored in the database based on the user input.

According to yet another aspect of the present application, the federal adjustments apply to a geographically distributed segments of an organizational entity.

According to still another aspect of the present application, the organizational entity is a telecommunications service providers.

According to one aspect of the present application, the tax platform is updated at periodic intervals.

According to another aspect of the present application, the data justifies adjustments made on income tax returns for an internal revenue service audit.

According to yet another aspect of the present application, the report is manually exported by the user.

According to still another aspect of the present application, the database is automatically backed up.

According to one aspect of the present application, the database is associated with a disaster recovery plan.

According to another aspect of the present application, the database is secured.

According to yet another aspect of the present application, the report is viewable by a second user.

According to still another aspect of the present application, the report is not modifiable by the second user.

According to one aspect of the present application, the report is modifiable by the user,

According to one aspect of the present application, an automated system of tracking federal adjustments includes a first receiver, implemented on at least one processor, that receives an automated upload at a database, from a tax platform of at least one of: a beginning balance, a thirteenth period adjustment and an ending balance for a general ledger account. The automated system includes a second receiver, implemented on the at least one processor, that receives user input specifying a type of tax report. The automated system also includes a generator, implemented on the at least one processor, that automatically generates and outputs to a user terminal, a report itemizing at least one of: data stored in the database and calculations based on the data stored in the database, in accordance with the user input.

According to one aspect of the present application, a tangible computer readable medium storing a computer program, recorded on the tangible computer readable medium, for automatically tracking federal adjustments includes a first receiving code segment, recorded on the tangible computer readable medium, that receives an automated upload at a database, from a tax platform implemented on at least one processor, of at least one of: a beginning balance, a thirteenth period adjustment and an ending balance for a general ledger account. The tangible computer readable medium includes a second receiving code segment, recorded on the tangible computer readable medium, that receives user input specifying a type of tax report. The tangible computer readable medium also includes a generating code segment, recorded on the tangible computer readable medium, that automatically generates and outputs to a user terminal, a report itemizing at least one of: data stored in the database and calculations based on the data stored in the database, in accordance with the user input.

According to one aspect of the present application, the federal adjustment tracking system (FedATS) tracks account balances, provides for manual input of various adjustment types, performs calculations based on adjustment type, provides reporting on adjustment data, and exports data to a vendor application (i.e., Corptax).

The federal adjustment tracking system database 200 is an integrated database that receives user input and provides account analyses such as, for example, federal M-1 calculations, federal M-1 summary reporting, and FAS109 tracking. The federal adjustment tracking system database 200 is accessible via the Internet via a web-based application. In one embodiment, the federal adjustment tracking system database 200 is implementable using a relational database (i.e., an Oracle database). The federal adjustment tracking system database 200 automatically creates a new tax year document and pre-populates beginning balances for tax-sensitive accounts by issue and general ledger account. Beginning balances for each general ledger account are obtained from a tax platform 202. In one embodiment, thirteenth period adjustments and ending balances are also automatically uploaded to the federal adjustment tracking system database 200. Automatically uploading the beginning balances ensures data accuracy and eliminates the need for manually obtaining beginning balances for each of the general ledger accounts in the tax platform 202.

The tax platform 202 collects general ledger account information for entities of an organization throughout the world. In one embodiment, state tax information is also collected. The general ledger account information is updated periodically.

The vendor application (e.g., the Corporate Federal Tax System and Earnings and Profit System, hereinafter “CorpTax”) 204a, implemented on a node 204b, provides accrual and extension information to the federal adjustment tracking database system 200 on a manual basis. The node 204b is a tangible physical device, that is, any hardware component upon which a software application is implementable. For example, the node 204b includes any of the following, but not limited to: a processor, a network element, a server, a computing device, a physical storage, database, data store and a physical memory. The vendor application computes federal income tax liability for each separate entity, as well as a consolidated federal income tax liability. The vendor application also generates corporate income tax returns and supporting work papers for compliance.

The federal adjustment tracking system database 200 receives user input from a user 206a operating a user terminal 206b via the Internet, an intranet, communications network or data network. The federal adjustment tracking system database 200 has a web-based interface frontend which allows the user 206a to specify account information. The federal adjustment tracking system database 200 returns reports based on the user input.

In one embodiment, the user input specifies a standard report. Standard reports itemize and reconcile differences in book to tax bases and differences between financial statements and a tax return. In particular, these standard reports itemize the above-described differences with respect to accruals, reversals, payments, reclasses, tax basis information if applicable, Fas 109 reporting and other issues transfers and other adjustments for a specified issue (e.g., legal reserves, pensions, stock options, and goodwill). Manual issues are also specifiable by the user 206a as user input. For example, the user 206a specifies either an M-1 amount or a custom Fas 109 report.

The federal adjustment tracking system database 200 performs calculations on demand to ensure consistent calculation of federal M-1 adjustments based on the user input. The federal adjustment tracking system database 200 ensures documentation and work papers necessary to justify adjustments made on income tax returns are available to a tax audit manager during an Internal Revenue Service (IRS) audit.

The federal adjustment tracking system database 200 produces reports including any of the following, but not limited to: M-1 summary, M-1 entry detail, issue reporting, FAS109 summary, FAS109 difference, general ledger balance, transfers and reclasses. These reports are manually exported by the user 206a. In one embodiment, the reports are generated in excel, and are uploaded to the vendor application 204a implemented on node 204b to create corporate income tax returns.

The federal adjustment tracking system database 200 provides tracking of book to tax basis for entities within an organization. In one embodiment, the legal entities of the organization are geographically distributed. In another embodiment, the organization is a telecommunications service provider. In yet another embodiment, the entities of the organization are located in foreign countries and are subject to tax laws in foreign countries. In still another embodiment, the data stored in the federal adjustment tracking system database 200 is automatically backed up and includes an associated disaster recovery plan, thereby ensuring proper data retention. In another embodiment, the segments of the organization are geographically distributed.

In one embodiment, the federal adjustment tracking database system 200 is secured and allows permitted users (having predefined qualifications) to access data stored in the federal adjustment tracking database system 200. In another embodiment, data and reports generated by other users are viewable, however, are not modifiable. In yet another embodiment, a user that enters data or generates a report is the only user permitted modification access to the data and the report.

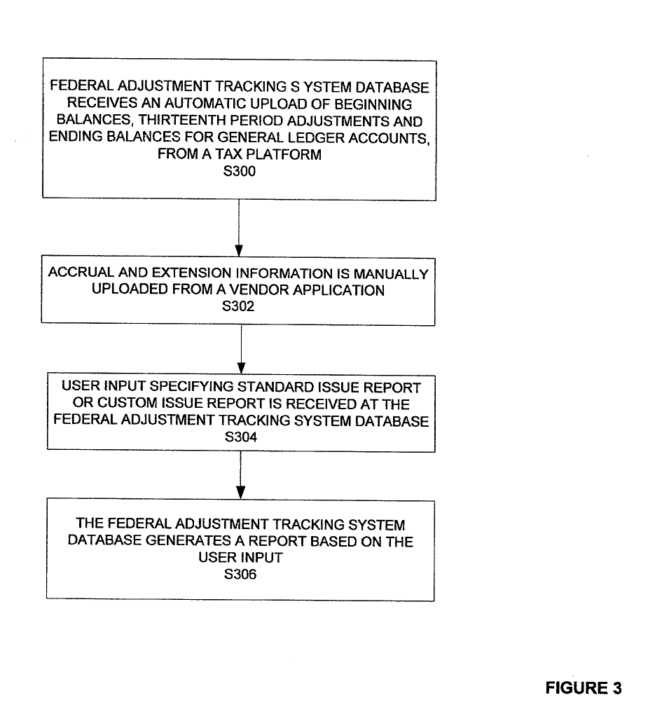

In FIG. 3, a process flow diagram illustrating federal adjustment tracking according to as aspect of the present application is shown. In step S300, a federal adjustment tracking system database receives beginning balances, thirteenth period adjustments and ending balances for general ledger accounts from a tax platform. In step S302, accrual and extension information is obtained from a vendor application (i.e., Corptax). In one embodiment, accrual and extension information is manually obtained. In step S304, a user enters user input designating a report type and search criteria, which will be explained in further detail below. In step S306, the federal adjustment tracking system database generates a report based on the user input. As discussed above, the reports include any of the following, but not limited to: M-1 summary, M-1 entry detail, issue reporting, Fas109 summary, Fas109 difference, general ledger balance, transfer and reclass reports.

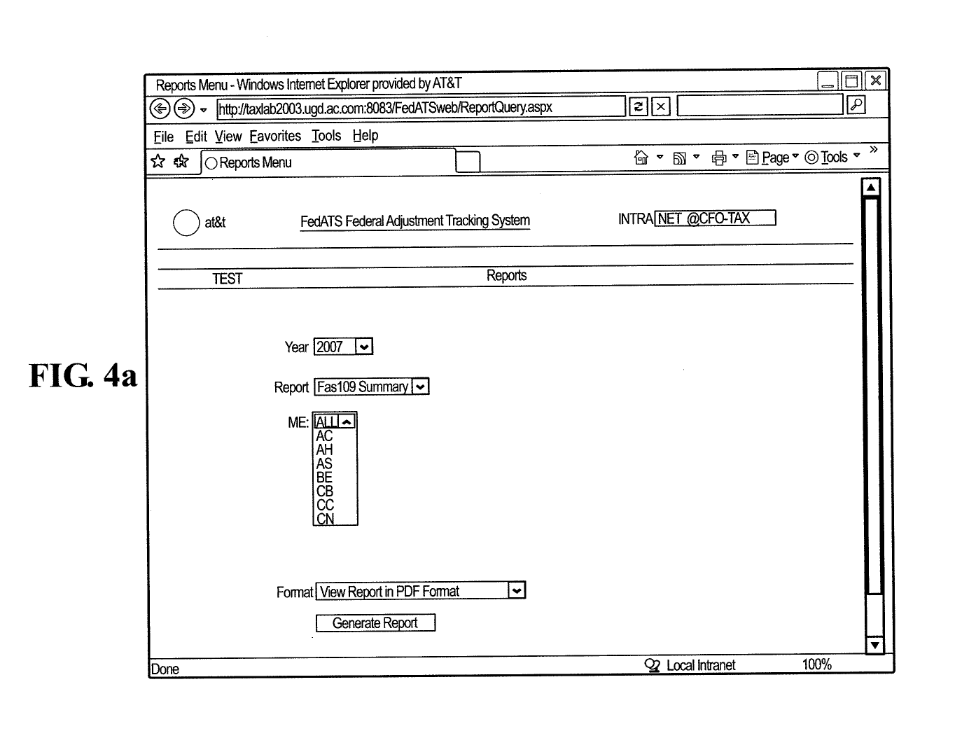

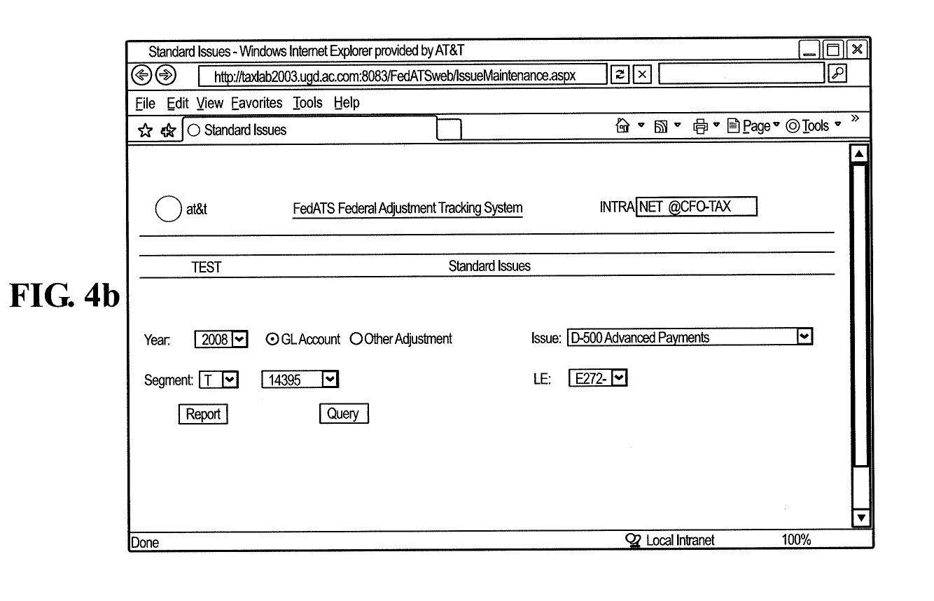

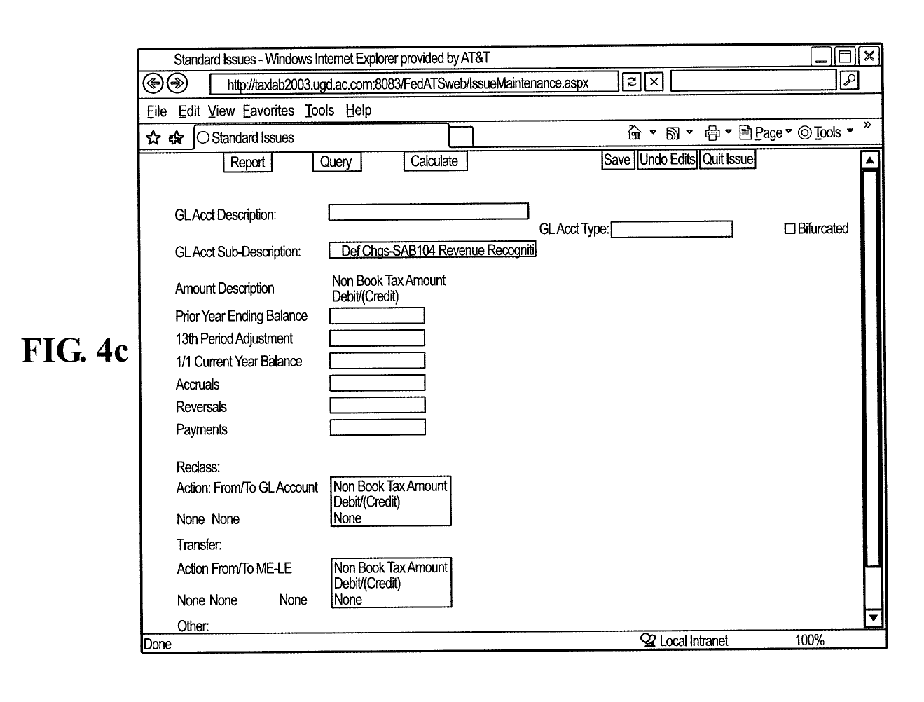

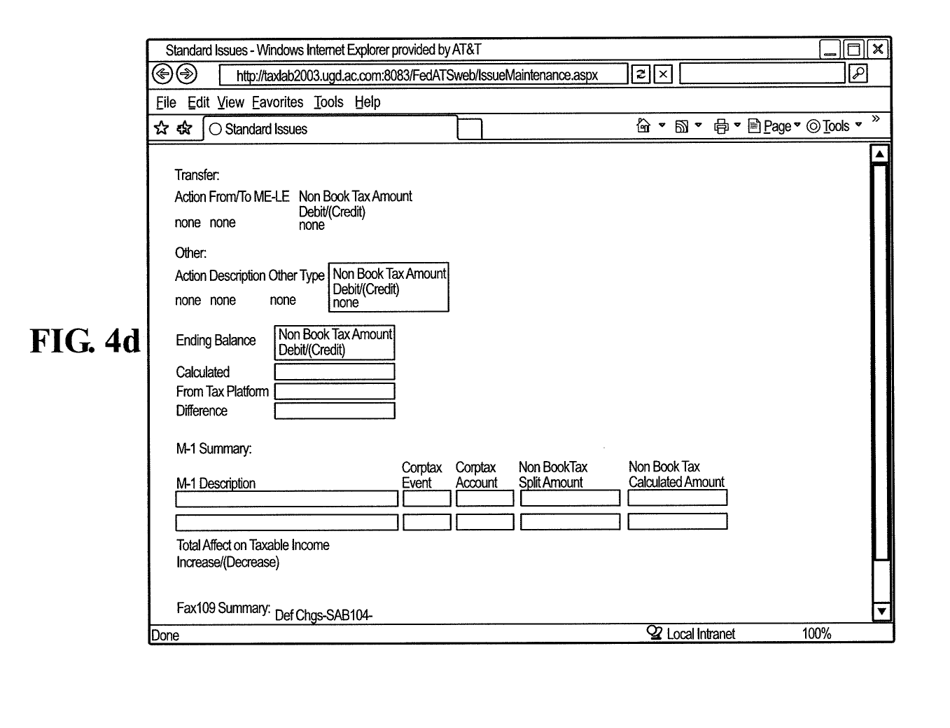

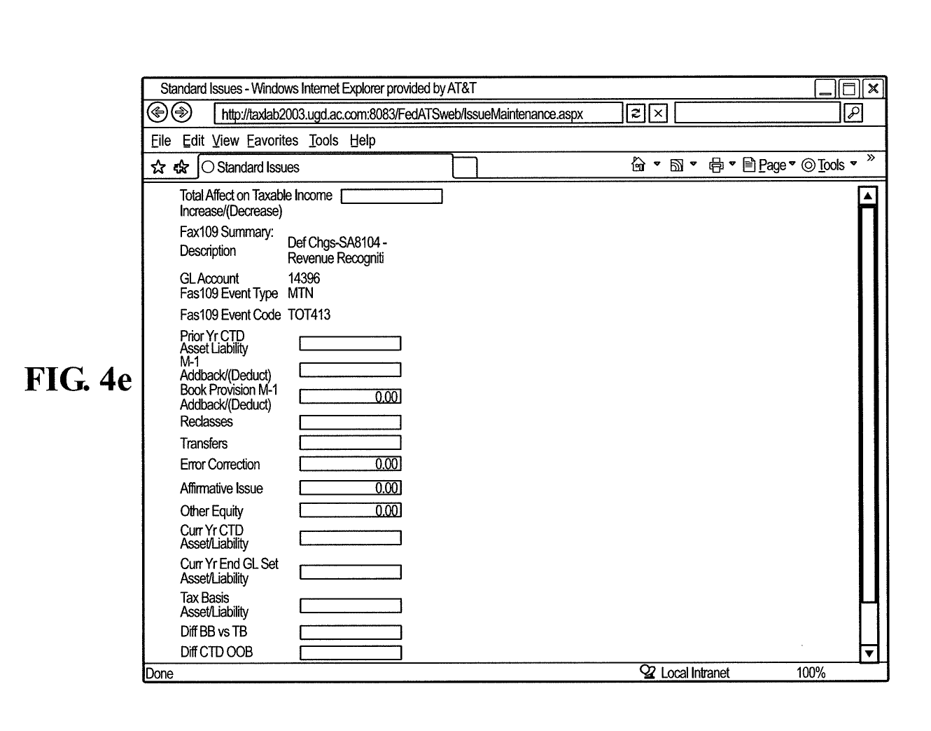

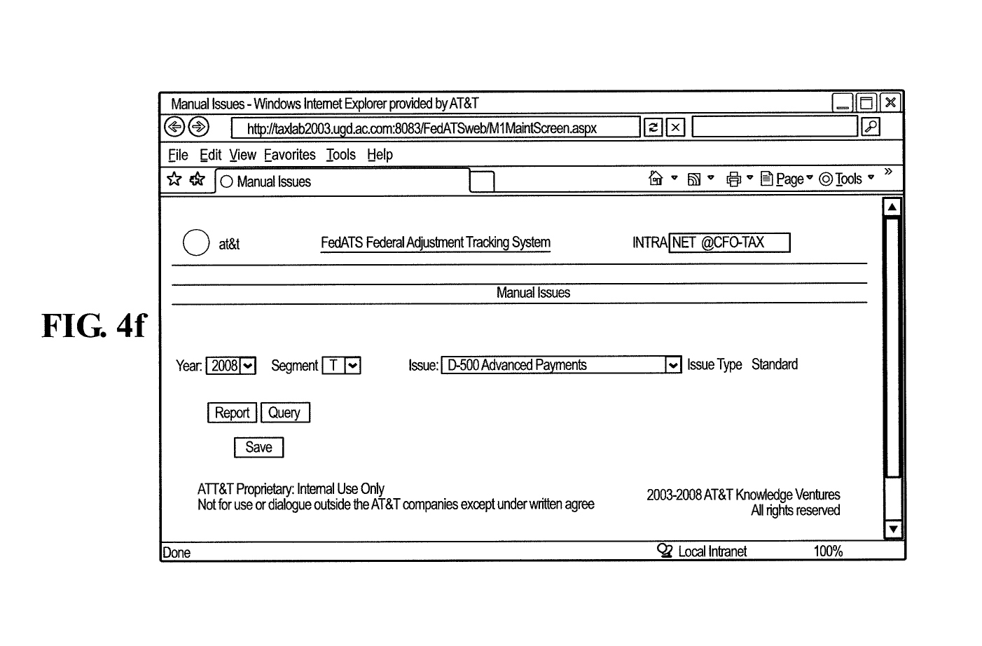

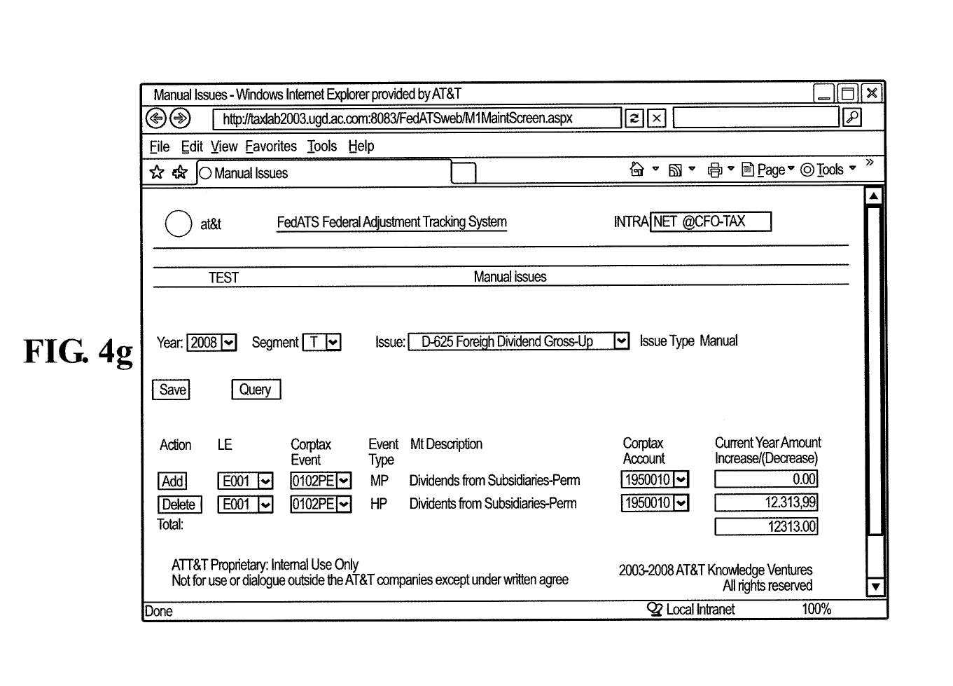

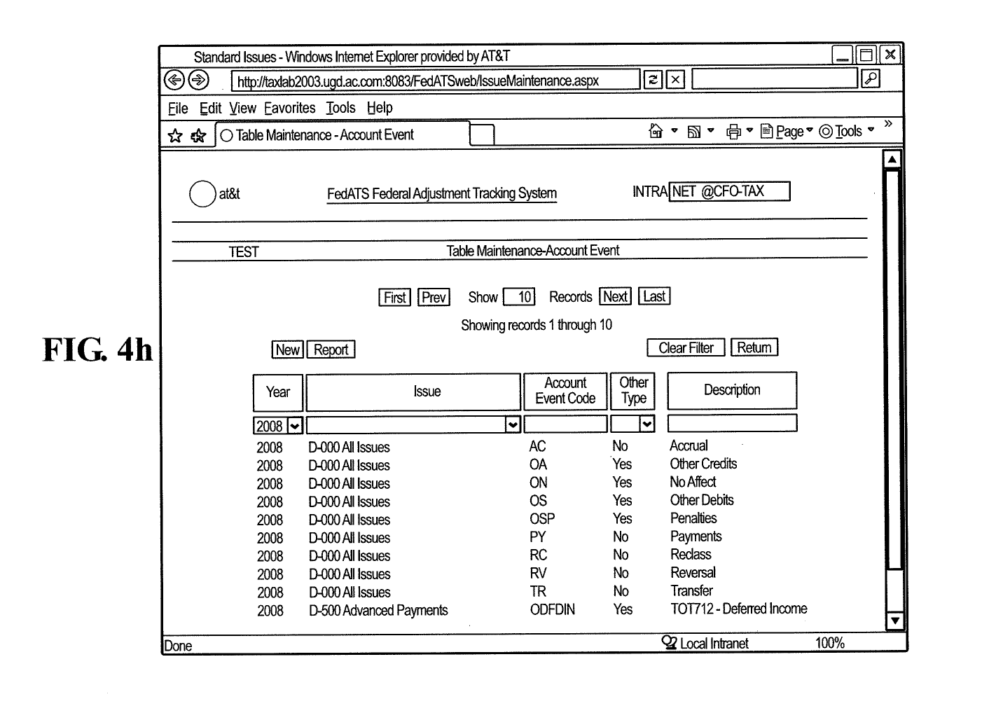

In FIG. 4a, a screen shot of a report screen of the web interface frontend of the federal adjustment tracking system is shown. The user generates a federal adjustment tracking system report by selecting a type of report and search criteria for the report. Search criteria includes a year for which to generate the report and a type of report (i.e., M-1 summary, M-1 entry detail, issue, segment roll forward, Fas 109 summary, Fas 109 difference, general ledger balance, reclass and transfer). In one embodiment, the user enters search criteria including any of the following, but not limited to: a selected issue, a sort option, a general ledger account if a segment roll forward report is selected, and an option to produce a report at a general account level of detail, if a M-1 entry detail report is selected. If the M-1 entry detail report is not selected, then a report is generated at a segment level. The user also enters a segment and legal entity for which to generate a report. The user is also enabled to select a report format (i.e., PDF, Microsoft Excel and raw data for export into Microsoft Excel).

In FIG. 4b, a screen shot of a standard issues screen of the web interface frontend of the federal adjustment tracking system is shown. The user selects a standard issues menu to view, add or update standard issue information. The user enters search criteria including any of the following, but not limited to a year, segment, issue, general ledger account option and associated accounts, other adjustment option and associated accounts, and a legal entity. In FIGS. 4c and 4d, screen shots of issue fields associated with the entered search criteria are shown. Issue fields include the following, but not limited to: prior year ending balance, thirteenth period adjustment, 1/1 current year balance, accruals, reversals, payments, reclass, transfer, other, ending balance (this field is calculated), ending balance obtained from the tax platform, ending balance difference, M-1 summary information (i.e., includes an action, M-1 description, a vendor application event, a split book amount and a calculated amount); a total effect on taxable income (i.e., sum of all M-1 amounts); and Fas109 summary.

The user is also enabled to view, add and update Fas109 summary information. In FIG. 4e, a screen shot of a Fas109 summary in a web interface frontend to the federal adjustment tracking system database is shown. The user enters search criteria including view (i.e., selecting “detail entries’ to view/update detail entries at the issue/general ledger account and legal entity level or selecting consolidated entries to view consolidated entries at the segment level), year, segment, issue, general ledger account option (i.e., selected if the user would like to view or update general ledger account associated with the issue selected), other adjustments option (i.e., if the user would like to view or update the other adjustments associated with the issue selected), legal entity and issue type (i.e., a non-editable field that indicates whether the issue is standard or manual).

Fas109 non-editable summary fields include the following, but are not limited to: a description (that describes the Fas109 detail); fas109 event type (indicates whether an event is a current, non-current or temporary equity); (fas109 event code (stores a vendor application even code associated with the event type); and prior year cumulative temporary difference.

Fas109 editable summary fields include any of the following, but not limited to: book provision M-1, error correction, affirmative issue and other equity. Fas109 calculated summary fields include any of the following, but not limited to: reclasses for general ledger accounts, transfers and M-1 information. Other summary fields include any of the following, but not limited to: current year cumulative temporary difference (i.e., a sum of the prior year's cumulative temporary difference, M-1, book provision M-1, reclasses, transfers, affirmative issue and other equity), current year ending general ledger balance, tax basis, difference book basis versus tax basis and difference cumulative temporary difference out of balance.

In FIG. 4f, a screen shot of a manual issues screen in a frontend web application interface to the federal adjustment tracking system database is shown. The user is also enabled to select manual issues to view, add or update M-1 summary information. To view an M-1 summary information, the user enters a year, segment, issue and issue type. As shown in FIG. 4g, M-1 summary fields include any of the following, but not limited to: action, legal entity, other category, event type, an editable m-1 description, a vendor application account, a current year amount, a general ledger account type and a total (which is the sum of all amounts).

In FIG. 4h, a screen shot of a table maintenance screen for accounting events in a web interface frontend to the federal adjustment tracking system database is shown. The user is enabled to update, modify and delete any of the following, but not limited to: a general ledger account for a given year, M-1 information for a given year and issue; other adjustment information for a given year and issue; an accounting event for a given year and issue; an issue for a given year; a segment or legal entity for a given year; accrual and extension information for a given year and issue; an fas109 non-event for a given year/issue; a year and a user profile.

Accordingly, the present invention enables federal adjustments tracking.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for databases and networks represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. An automated method of tracking federal adjustments, comprising:
receiving an automated upload at a database, from a tax platform implemented on at least one processor, of at least one of: a beginning balance, a thirteenth period adjustment and an ending balance for a general ledger account;
receiving user input specifying a type of tax report; and
automatically generating and outputting to a user terminal, a report itemizing at least one of: data stored in the database and calculations based on the data stored in the database, in accordance with the user input.

2. The automated method according to claim 1, further comprising:
receiving a manual upload, at the database, from a vendor application implemented on a second processor.

3. The automated method according to claim 1,
wherein the user input designates a standard issue or a manual issue.

4. The automated method according to claim 3,
wherein the user input further comprises a year, a selected issue, a general ledger account, a segment, a legal entity and a report format.

5. The automated method according to claim 3,
wherein a subset of data elements itemized by the report are editable.

6. The automated method according to claim 1, further comprising:
updating the data stored in the database based on the user input.

7. The automated method according to claim 1,
wherein the federal adjustments apply to a geographically distributed segments of an organizational entity.

8. The automated method according to claim 7,
wherein the organizational entity is a telecommunications service providers.

9. The automated method according to claim 1,
wherein the tax platform is updated at periodic intervals.

10. The automated method according to claim 1,
wherein the data justifies adjustments made on income tax returns for an internal revenue service audit.

11. The automated method according to claim 1,
wherein the report is manually exported by the user.

12. The automated method according to claim 1,
wherein the database is automatically backed up.

13. The automated method according to claim 1,
wherein the database is associated with a disaster recovery plan.

14. The automated method according to claim 1,
wherein the database is secured.

15. The automated method according to claim 1,
wherein the report is viewable by a second user.

16. The automated method according to claim 1,
wherein the report is not modifiable by the second user.

17. The automated method according to claim 1,
wherein the report is modifiable by the user.

18. An automated system of tracking federal adjustments, comprising:
a first receiver, implemented on at least one processor, that receives an automated upload at a database, from a tax platform of at least one of: a beginning balance, a thirteenth period adjustment and an ending balance for a general ledger account;
a second receiver, implemented on the at least one processor, that receives user input specifying a type of tax report; and
a generator, implemented on the at least one processor, that automatically generates and outputs to a user terminal, a report itemizing at least one of: data stored in the database and calculations based on the data stored in the database, in accordance with the user input.

19. A tangible computer readable medium storing a computer program, recorded on the tangible computer readable medium, for automatically tracking federal adjustments, comprising:
a first receiving code segment, recorded on the tangible computer readable medium, that receives an automated upload at a database, from a tax platform implemented on at least one processor, of at least one of: a beginning balance, a thirteenth period adjustment and an ending balance for a general ledger account;
a second receiving code segment, recorded on the tangible computer readable medium, that receives user input specifying a type of tax report; and
a generating code segment, recorded on the tangible computer readable medium, that automatically generates and outputs to a user terminal, a report itemizing at least one of: data stored in the database and calculations based on the data stored in the database, in accordance with the user input.
